(19) United States
(12) Patent Application Publication
(10) Pub. No.: US 2019/0011570 A1
(43) Pub. Date: Jan. 10, 2019

(54) GNSS DEVICE LOCATION VERIFICATION

(71) Applicant: JAVAD GNSS, Inc., San Jose, CA (US)

(72) Inventor: Javad ASHJAEE, Saratoga, CA (US)

(21) Appl. No.: 15/644,689

(22) Filed: Jul. 7, 2017

(51) Int. Cl. G01S 19/44; G01S 19/52; G01S 19/47; G01S 19/23; G01S 19/04; G01S 19/07

(52) U.S. Cl. CPC G01S 19/44; G01S 19/52; G01S 19/07; G01S 19/23; G01S 19/04; G01S 19/47

(57) ABSTRACT

Systems and methods are provided for verifying a location of a global navigation satellite system (GNSS) base station or rover. In one example, a method for verifying a location of a GNSS base station includes measuring velocity of the GNSS base station, determining movement of the GNSS base station based on the measured velocity, and, in response to determining movement of the GNSS base station, transmitting a movement alert to a GNSS rover.

### BACKGROUND

### 1. Field

The present disclosure relates to Global Navigation Satellite System (GNSS) devices and, more specifically, to verifying whether GNSS devices have changed location.

### 2. Related Art

Navigation receivers that use global navigation satellite systems, such as GPS or GLONASS (hereinafter collectively referred to as “GNSS”), enable a highly accurate determination of the position of the receiver. The satellite signals may include carrier harmonic signals that are modulated by pseudo-random binary codes and that, on the receiver side, may be used to measure the delay relative to a local reference clock. These delay measurements may be used to determine the pseudo-ranges between the receiver and the satellites. The pseudo-ranges are not true geometric ranges because the receiver's local clock may be different from the satellite onboard clocks. If the number of satellites in sight is greater than or equal to four, then the measured pseudo-ranges can be processed to determine the user's single point location as represented by a vector X=(x, y, z)^{T}, as well as to compensate for the receiver clock offset.

GNSS finds particular application in the field of surveying, which requires highly accurate measurements. The need to improve positioning accuracies has eventually led to the development of differential navigation/positioning. In this mode, the user position is determined relative to an antenna connected to a base receiver or a network of base receivers with the assumption that the positional coordinates of the base receiver(s) are known with high accuracy. The base receiver or receiver network transmits its measurements (or corrections to the full measurements) to a mobile navigation receiver (or rover). The rover receiver uses these corrections to refine its measurements in the course of data processing. The rationale for this approach is that since the pseudo-range measurement errors on the base and rover sides are strongly correlated, using differential measurements will substantially improve positioning accuracy.

Typically, the base is static and located at a known position. However, in relative navigation mode, both the base and rover are moving. In this mode, the user is interested in determining the vector between the base and the rover. In other words, the user is interested in determining the continuously changing rover position relative to the continuously changing position of the base. For example, when one aircraft or space vehicle is approaching another for in-flight refueling or docking, a highly accurate determination of relative position is important, while the absolute position of each vehicle is generally not critical.

The position of the rover changes continuously in time, and thus should be referenced to a time scale. The determination of the position of a mobile rover with respect to a base receiver in real-time may be performed using an RTK algorithm, which may be stored in memory on the rover. As the name “real-time kinematic” implies, the rover receiver is capable of calculating/outputting its precise position as the raw data measurements and differential corrections become available at the rover. When implementing an RTK algorithm, a data communication link (e.g., a radio communication link, a GSM binary data communication link etc.) may be used to transmit the necessary information from the base to the rover.

Further improvement of the accuracy in differential navigation/positioning applications can be achieved by using both the carrier phase and pseudo-range measurements from the satellites to which the receivers are locked. For example, by measuring the carrier phase of the signal received from a satellite in the base receiver and comparing it with the carrier phase of the same satellite measured in the rover receiver, one can obtain measurement accuracy to within a small fraction of the carrier's wavelength.

One well-known type of measurement error that can reduce the accuracy of differential navigation/positioning is multipath error. Multipath errors are caused by the reflection of the GNSS satellite signals by surfaces located near the receiving antenna. As a result of these reflections, the antenna receives both the direct signal traveling the shortest path from the satellite to the receiver as well as the reflected signals following indirect paths. The combination of two (or more) signals at the antenna leads to the distortion of raw measurements. Multipath errors may affect both pseudo-range and carrier phase measurements.

### BRIEF SUMMARY

Systems and methods for verifying a location of a global navigation satellite system (GNSS) device are provided. The GNSS device may be a base station or a rover. In one example, a GNSS base station measures velocity of the GNSS base station, determines movement of the GNSS base station based on the measured velocity, and, in response to determining movement of the GNSS base station, transmits a movement alert to a GNSS rover.

In some examples, determining movement of the GNSS base station includes determining the measured velocity exceeds a threshold velocity. In some examples, determining movement of the GNSS base station includes determining the GNSS base station moved more than a minimum distance based on the measured velocity. In some examples, measuring the velocity of the GNSS base station includes repeatedly detecting a current velocity of the GNSS base station. In some examples, the current velocity is detected 10 times per second. In some examples, the velocity is measured with an accelerometer. In some examples, acceleration of the GNSS base station is measured, and movement of the GNSS base station is determined based on the measured velocity and the measured acceleration. In some examples, a tilt angle of the GNSS base station is measured (e.g., with an inclinometer), and movement of the GNSS base station is determined based on the measured velocity and the measured tilt angle.

In another example, a GNSS rover measures velocity of the GNSS rover, determines a first movement value based on the measured velocity of the GNSS rover, determines a second movement value based on two consecutive real time kinematic (RTK) positions of the GNSS rover, compares the first movement value and the second movement value, and, in accordance with a determination that a difference between the first movement value and the second movement value is greater than a threshold, resets one or more RTK engines in the GNSS rover.

In some examples, determining the first movement value includes determining the measured velocity of the GNSS rover exceeds a threshold velocity. In some examples, determining the first movement value includes determining the GNSS rover moved more than a minimum distance based on the measured velocity. In some examples, measuring the velocity of the GNSS rover comprises repeatedly detecting a current velocity of the GNSS rover. In some examples, the current velocity is detected 10 times per second. In some examples, the velocity is measured with an accelerometer. In some examples, the GNSS rover provides an alert to indicate a potential error in the RTK positions.

### BRIEF DESCRIPTION OF THE DRAWINGS

FIG. 1 illustrates an exemplary GNSS receiver that may be used within a GNSS device, according to various examples.

FIG. 2 illustrates an exemplary process for verifying a location of a GNSS base station, according to various examples.

FIG. 3 illustrates an exemplary process for verifying a location of a GNSS rover, according to various examples.

In the following description, reference is made to the accompanying drawings which form a part thereof, and which illustrate several examples of the present disclosure. It is understood that other examples may be utilized and structural and operational changes may be made without departing from the scope of the present disclosure. The use of the same reference symbols in different drawings indicates similar or identical items.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the technology as claimed. Thus, the various embodiments are not intended to be limited to the examples described herein and shown, but are to be accorded the scope consistent with the claims.

The accuracy of the positional coordinates of a base station receiver is important in calculating an accurate position of a rover. If the positional coordinates of the base station are inaccurate, then the rover's coordinates will be similarly affected. In some cases, the positional coordinates of the base station may be accurately entered, but then the base station is later inadvertently moved (e.g., by the wind, an animal bumping the base station, etc.). In these cases, the rover may assume the base station's coordinates are still accurate because the rover is unaware of the inadvertent movement of the base station. Some of the embodiments of the technology described below address this issue by alerting the rover to the inadvertent movement of the base station so that the movement can be corrected for, as necessary.

The movement of the base station is detected by measuring the velocity (or changes in velocity) of the base station. If it is determined that a movement occurred, then an alert is sent to the rover. The operator of the rover may then verify and/or correct the location of the base station.

A similar technique may be used to determine if the rover is experiencing errors with its positioning. Real time kinematic (RTK) engines in the rover may have wrong ambiguity fixing that may cause large position errors in the rover (e.g., up to several feet). The velocity (or changes in velocity) of the rover is measured and compared to two consecutive real time kinematic (RTK) position solutions calculated by the rover. If the velocity measurements and RTK positions do not indicate similar movements (within margins), then one or more RTK engines are reset to recalculate the position of the rover. This technique can be used to verify the RTK engines are functioning properly.

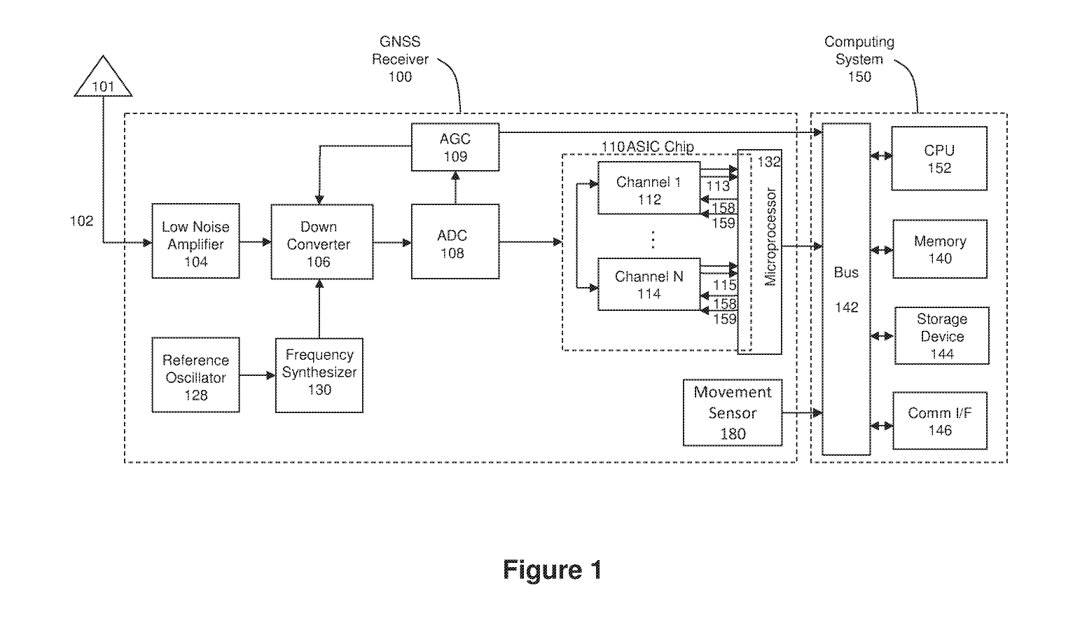

FIG. 1 illustrates an exemplary GNSS receiver 100 that may be used within a GNSS device, according to various examples. The GNSS device may be a GNSS base station or a GNSS rover. GNSS receiver 100 may receive GNSS signals 102, such as GPS or GLONASS signals, via a GNSS antenna 101. GNSS signal 102 may contain two pseudo-noise (“PN”) code components, a coarse code, and a precision code residing on orthogonal carrier components, which may be used by GNSS receiver 100 to determine the position of the GNSS receiver. For example, a typical GNSS signal 102 may include a carrier signal modulated by two PN code components. The frequency of the carrier signal may be satellite specific. Thus, each GNSS satellite may transmit a GNSS signal at a different frequency.

GNSS receiver 100 may further include a low noise amplifier 104, a reference oscillator 128, a frequency synthesizer 130, a down converter 106, an automatic gain control (AGC) 109, and an analog-to-digital converter (ADC) 108. These components may perform amplification, filtering, frequency down-conversion, and sampling. The reference oscillator 128 and frequency synthesizer 130 may generate a frequency signal to down convert the GNSS signals 102 to baseband or to an intermediate frequency that depends on the entire receiver frequency plan design and available electronic components. The ADC 108 may then convert the GNSS signals 102 to a digital signal by sampling multiple repetitions of the GNSS signals 102.

GNSS receiver 100 may further include multiple GNSS channels, such as channels 112 and 114. It should be understood that any number of channels may be provided to receive and demodulate GNSS signals 102 from any number of satellites. The GNSS channels 112 and 114 may each contain a demodulator to demodulate a GNSS PN code contained in ADC signal 109, a PN code reference generator, a numerically controlled oscillator (code NCO) to drive the PN code generator as well as a carrier frequency demodulator (e.g., a phase detector of a phase locked loop—PLL), and a numerically controlled oscillator to form a reference carrier frequency and phase (carrier NCO). In one example, the numerically controlled oscillator (code NCO) of channels 112 and 114 may receive code frequency/phase control signal 158 as input. Further, the numerically controlled oscillator (carrier NCO) of channels 112 and 114 may receive carrier frequency/phase control signal 159 as input.

In one example, the processing circuitry for the GNSS channels may reside in an application specific integrated circuit (“ASIC”) chip 110. When a corresponding frequency is detected, the appropriate GNSS channel may use the embedded PN code to determine the distance of the receiver from the satellite. This information may be provided by GNSS channels 112 and 114 through channel output vectors 113 and 115, respectively. Channel output vectors 113 and 115 may each contain four signals forming two vectors—inphase I and quadriphase Q which are averaged signals of the phase loop discriminator (demodulator) output, and inphase dl and quadriphase dQ—averaged signals of the code loop discriminator (demodulator) output.

The GNSS receiver 100 may further include a movement sensor 180. Alternatively, the movement sensor 180 may be a separate component from the GNSS receiver 100. The movement sensor 180 may be an accelerometer or other sensing device capable of detecting movement. The movement sensor 180 measures velocity (or changes in velocity) of the GNSS device. In some examples, measuring the velocity of the GNSS device includes repeatedly detecting a current velocity of the GNSS device. For example, the movement sensor 180 may detect the current velocity of the GNSS device 10 times per second.

In some examples, the movement sensor 180 also measures acceleration and/or tilt angle of the GNSS device. For example, the movement sensor 180 may include an inclinometer that can detect when the GNSS device changes angles.

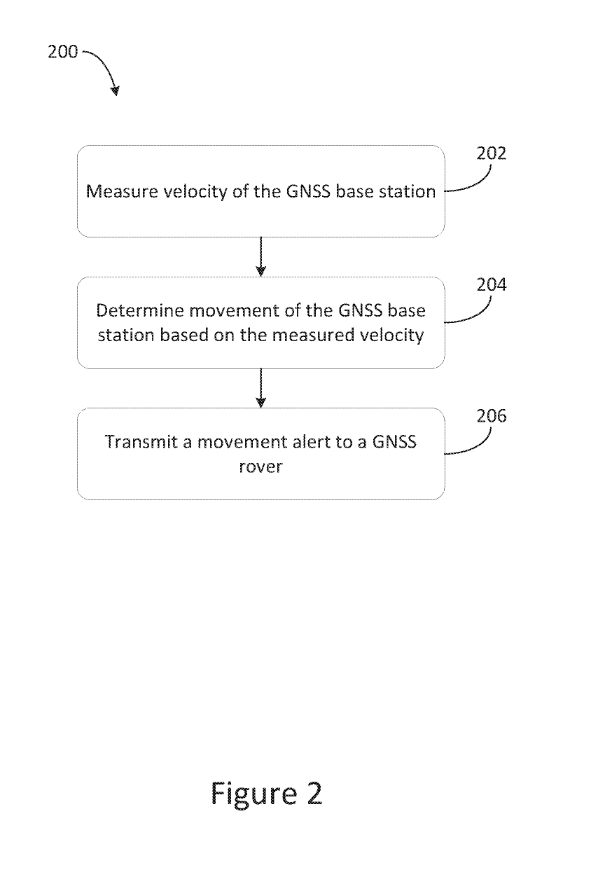

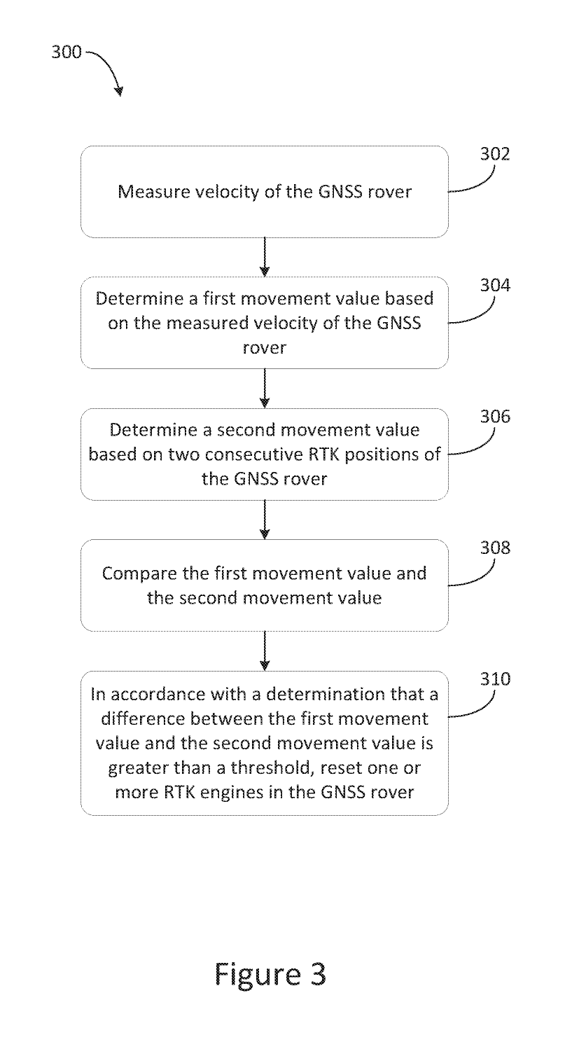

In some examples, a computing system 150 may be coupled to receive position information (e.g., in the form of channel output vectors 113 and 115 or any other representation of position) from the GNSS receiver 100 and movement information from the movement sensor 180. Computing system 150 may include processor-executable instructions for performing location verification (e.g., for performing process 200 or 300, described in greater detail below with respect to FIGS. 2-3), stored in memory 140. The instructions may be executable by one or more processors, such as a CPU 152. However, those skilled in the relevant art will also recognize how to implement the current technology using other computer systems or architectures. CPU 152 may be implemented using a general or special purpose processing engine such as, for example, a microprocessor, microcontroller or other control logic. In this example, CPU 152 is connected to a bus 142 or other communication medium.

Memory 140 may include read only memory (“ROM”) or other static storage device coupled to bus 142 for storing static information and instructions for CPU 152. Memory 140 may also include random access memory (RAM) or other dynamic memory, for storing information and instructions to be executed by CPU 152. Memory 140 may also be used for storing temporary variables or other intermediate information during execution of instructions to be executed by CPU 152.

Computing system 150 may further include an information storage device 144 coupled to bus 142. The information storage device may include, for example, a media drive (not shown) and a removable storage interface (not shown). The media drive may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media may include, for example, a hard disk, floppy disk, magnetic tape, optical disk, CD or DVD, or other fixed or removable medium that is read by and written to by media drive. As these examples illustrate, the storage media may include a non-transitory computer-readable storage medium having stored therein particular computer software or data.

In other examples, information storage device 144 may include other similar instrumentalities for allowing computer programs or other instructions or data to be loaded into computing system 150. Such instrumentalities may include, for example, a removable storage unit (not shown) and an interface (not shown), such as a program cartridge and cartridge interface, a removable memory (e.g., a flash memory or other removable memory module) and memory slot, and other removable storage units and interfaces that allow software and data to be transferred from the removable storage unit to computing system 150.

Computing system 150 may further include a communications interface 146. Communications interface 146 may be used to allow software and data to be transferred between computing system 150 and external devices. Examples of communications interface 146 may include a modem, a network interface (such as an Ethernet or other NIC card), a communications port (such as for example, a USB port), a PCMCIA slot and card, etc. Software and data transferred via communications interface 146. Some examples of a communication interface 146 include a phone line, a cellular phone link, an RF link, a network interface, a local or wide area network, and other communications channels.

In some examples, GNSS receiver 100 and computing system 150 may be included within a handheld GNSS device, similar or identical to that described in U.S. patent application Ser. No. 12/871,705, filed Aug. 30, 2010, issued as U.S. Pat. No. 8,125,376, and assigned to the assignee of the present application, which is incorporated herein by reference in its entirety for all purposes. For example, the handheld GNSS device may include a display, orientation sensors, distance sensors, a camera, a compass, and the like, coupled to GNSS receiver 100 and/or computing system 150 described in reference to FIG. 1.

FIG. 2 illustrates an exemplary process 200 for verifying a location of a GNSS base station, according to various examples. In some examples, process 200 may be performed by a GNSS base station having a GNSS receiver and computing system similar or identical to GNSS receiver 100 and computing system 150.

At block 202, velocity (or changes in velocity) of a GNSS base station is measured. The velocity (or changes in velocity) of the GNSS base station may be measured with a movement sensor (e.g., an accelerometer) in the GNSS base station. The velocity is measured by repeatedly detecting a current velocity of the GNSS base station. For example, the current velocity may be measured 10 times per second. While the GNSS base station is stationary, the measured velocity is approximately zero. However, if the base station moves, then the measured velocity will be a non-zero value.

Optionally, acceleration of the base station is also measured with the movement sensor (e.g., an accelerometer). Alternatively or in addition, a tilt angle of the base station may be measured with an inclinometer in the base station. The acceleration and tilt angle measurements may be used in addition to the velocity measurements to determine movement of the GNSS base station.

At block 204, movement of the GNSS base station is determined based on the measured velocity. Optionally, acceleration and/or tilt angle measurements may also be used in determining movement of the GNSS base station. In some examples, determining movement of the GNSS base station includes determining the measured velocity exceeds a threshold velocity. For example, if the measured velocity is greater than 0.1 m/s, then the GNSS base station may determine that a movement occurred. In some examples, determining movement of the GNSS base station may include determining the GNSS base station moved more than a minimum distance based on the measured velocity. For example, the GNSS base station may be required to move more than 1 inch in order for a movement to be determined.

At block 206, a movement alert is transmitted to a GNSS rover. The movement alert informs the GNSS rover that the location of the GNSS base station may have changed. After receiving the movement alert, an operator of the GNSS rover may verify the location of the GNSS base station and make adjustments as necessary.

FIG. 3 illustrates an exemplary process 300 for verifying a location of a GNSS rover, according to various examples. In some examples, process 300 may be performed by a GNSS rover having a GNSS receiver and computing system similar or identical to GNSS receiver 100 and computing system 150 described in reference to FIG. 1.

At block 302, velocity (or changes in velocity) of a GNSS rover is measured. The velocity (or changes in velocity) of the GNSS rover may be measured with a movement sensor (e.g., an accelerometer) in the GNSS rover. The velocity is measured by repeatedly detecting a current velocity of the GNSS rover. For example, the current velocity may be measured 10 times per second. While the GNSS rover is stationary, the measured velocity is approximately zero. However, if the rover moves, then the measured velocity will be a non-zero value.

At block 304, a first movement value is determined based on the measured velocity of the GNSS rover. The first movement value indicates that the movement sensor detected movement of the GNSS rover. In some examples, determining the first movement value includes determining that the measured velocity exceeds a threshold velocity. For example, the measured velocity may need to exceed 0.1 m/s in order for the first movement value to be determined. In some examples, determining the first movement value may include determining the GNSS rover moved more than a minimum distance based on the measured velocity. For example, the GNSS rover may be required to move more than 1 inch in order for the first movement value to be determined.

At block 306, a second movement value is determined based on two consecutive real time kinematic (RTK) positions of the GNSS rover. If the two consecutive RTK positions differ by more than a minimum amount, then the second movement value will indicate possible movement of the GNSS rover.

At block 308, the first movement value and the second movement value are compared. If both movement values indicate a similar movement, then no action is taken. However, if the first movement value indicates a movement of the GNSS rover and the second movement value does not indicate a movement of the GNSS rover, then an error may have occurred in one or more RTK engines that determine the rover's RTK position. In this case, one or more RTK engines are reset. Resetting the RTK engine(s) results in a recalculation of the rover's position which may fix the error. Similarly, if the second movement value indicates a movement of the GNSS rover and the first movement value does not indicate a movement of the GNSS rover, then one or more of the RTK engines may be falsely detecting movement and may be reset.

In some examples, an alert may also be provided to the operator of the GNSS rover to indicate the potential errors in the RTK positions.

A more detailed description of determining a position based on signals from GNSS satellites and base stations is available in U.S. Pat. No. 8,120,527, filed. Jan. 27, 2009, assigned to the assignee of the present application, and which is incorporated herein by reference in its entirety for all purposes. Additionally, a more detailed description of determining a position using multiple RTK engines is available in U.S. Pat. No. 8,872,700, filed Apr. 2, 2012, and U.S. patent application Ser. No. 15/418,474, filed Jan. 27, 2017, assigned to the assignee of the present application, and which are incorporated herein by reference in their entireties for all purposes.

It will be appreciated that, for clarity purposes, the above description has described examples with reference to different functional units and processors. However, it will be apparent that any suitable distribution of functionality between different functional units, processors, or domains may be used. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Furthermore, although individually listed, a plurality of means, elements, or method steps may be implemented by, for example, a single unit or processor. Additionally, although individual features may be included in different claims, these may possibly be advantageously combined, and the inclusion in different claims does not imply that a combination of features is not feasible or advantageous. Also, the inclusion of a feature in one category of claims does not imply a limitation to this category, but rather the feature may be equally applicable to other claim categories, as appropriate.

Although a feature may appear to be described in connection with a particular embodiment, one skilled in the art would recognize that various features of the described embodiments may be combined. Moreover, aspects described in connection with an embodiment may stand alone.

What is claimed is:

1. A method for verifying a location of a global navigation satellite system (GNSS) base station, the method comprising:
measuring velocity of the GNSS base station;
determining movement of the GNSS base station based on the measured velocity; and
in response to determining movement of the GNSS base station, transmitting a movement alert to a GNSS rover.

2. The method of claim 1, wherein determining movement of the GNSS base station comprises determining the measured velocity exceeds a threshold velocity.

3. The method of claim 1, wherein determining movement of the GNSS base station comprises determining the GNSS base station moved more than a minimum distance based on the measured velocity.

4. The method of claim 1, wherein measuring the velocity of the GNSS base station comprises repeatedly detecting a current velocity of the GNSS base station.

5. The method of claim 4, wherein the current velocity is detected 10 times per second.

6. The method of claim 1, further comprising:
measuring acceleration of the GNSS base station;
determining movement of the GNSS base station based on the measured velocity and the measured acceleration.

7. The method of claim 1, further comprising:
measuring a tilt angle of the GNSS base station;
determining movement of the GNSS base station based on the measured velocity and the measured tilt angle.

8. A global navigation satellite system (GNSS) base station, comprising:
a movement sensor;
one or more processors; and
memory storing one or more programs configured to be executed by the one or more processors, the one or more programs including instructions for:
measuring velocity of the GNSS base station with the movement sensor;
determining movement of the GNSS base station based on the measured velocity; and
in response to determining movement of the GNSS base station, transmitting a movement alert to a GNSS rover.

9. The GNSS base station of claim 8, wherein determining movement of the GNSS base station comprises determining the measured velocity exceeds a threshold velocity.

10. The GNSS base station of claim 8, wherein determining movement of the GNSS base station comprises determining the GNSS base station moved more than a minimum distance based on the measured velocity.

11. The GNSS base station of claim 8, wherein measuring the velocity of the GNSS base station comprises repeatedly detecting a current velocity of the GNSS base station.

12. The GNSS base station of claim 11, wherein the current velocity is detected 10 times per second.

13. The GNSS base station of claim 8, wherein the movement sensor is an accelerometer.

14. The GNSS base station of claim 8, the one or more programs further including instructions for:
measuring acceleration of the GNSS base station;
determining movement of the GNSS base station based on the measured velocity and the measured acceleration.

15. The GNSS base station of claim 8, the one or more programs further including instructions for:
measuring a tilt angle of the GNSS base station.
determining movement of the GNSS base station based on the measured velocity and the measured tilt angle.

16. A method for verifying a location of a global navigation satellite system (GNSS) rover, the method comprising:
measuring velocity of the GNSS rover;
determining a first movement value based on the measured velocity of the GNSS rover;
determining a second movement value based on two consecutive real time kinematic (RTK) positions of the GNSS rover;
comparing the first movement value and the second movement value; and
in accordance with a determination that a difference between the first movement value and the second movement value is greater than a threshold, resetting one or more RTK engines in the GNSS rover.

17. The method of claim 16, wherein determining the first movement value comprises determining the measured velocity of the GNSS rover exceeds a threshold velocity.

18. The method of claim 16, wherein determining the first movement value comprises determining the GNSS rover moved more than a minimum distance based on the measured velocity.

19. The method of claim 16, wherein measuring the velocity of the GNSS rover comprises repeatedly detecting a current velocity of the GNSS rover.

20. The method of claim 19, wherein the current velocity is detected 10 times per second.

21. The method of claim 16, wherein the velocity is measured with an accelerometer.

22. The method of claim 16, further comprising:
providing an alert to indicate a potential error in the RTK positions.

23. A global navigation satellite system (GNSS) rover, comprising:
a movement sensor;
one or more processors; and
memory storing one or more programs configured to be executed by the one or more processors, the one or more programs including instructions for:
measuring velocity of the GNSS rover;
determining a first movement value based on the measured velocity of the GNSS rover;
determining a second movement value based on two consecutive real time kinematic (RTK) positions of the GNSS rover;
comparing the first movement value and the second movement value; and
in accordance with a determination that a difference between the first movement value and the second movement value is greater than a threshold, resetting one or more RTK engines in the GNSS rover.
